(19) United States
(12) Patent Application Publication
(10) Pub. No.: US 2016/0327003 A1
(43) Pub. Date: Nov. 10, 2016

(54) SYSTEM FOR DETERMINING INJECTOR SPRAY PATTERN

(71) Applicant: Caterpillar Inc., Peoria, IL (US)

(72) Inventors: Ryan M. Noe, East Peoria, IL (US); Keith D. Hogan, Peoria Heights, IL (US)

(73) Assignee: Caterpillar Inc., Peoria, IL (US)

(21) Appl. No.: 15/214,121

(22) Filed: Jul. 19, 2016

(51) Int. Cl. F02M 65/00; F01N 3/20

(52) U.S. Cl. CPC F02M 65/00; F01N 3/206

(57) ABSTRACT

A system for determining a spray pattern of an injector is disclosed. The system includes a chamber having a means for mounting the injector and a grid disposed within the chamber, the grid includes an array of orifices to receive fluid sprayed by the injector. The system also includes multiple containers positioned beneath the chamber for collecting the fluid and multiple tubes to connect the grid to the multiple containers, where each tube allows flow of fluid from an orifice to a container. The system also includes a multiple load cells to generate a voltage signal corresponding to an amount of fluid collected in each container and multiple solenoids to drain the fluid from each container. Further, the system includes a control module to generate an output indicative of the amount of fluid collected in each container and a distribution pattern of the collected fluid.

### TECHNICAL FIELD

The present disclosure relates to injectors and more particularly to a system for determining a spray pattern of an injector.

### BACKGROUND

Typically, injectors are employed in an engine to inject fluid, such as fuel, for initiating combustion in the engine. Besides assisting in combustion, injectors, such as Diesel Exhaust Fluid (DEF) injectors, are also employed in an exhaust after-treatment system of the engine to minimize oxides of nitrogen (NOx). In such applications where the injectors are deployed in the exhaust after-treatment system, it is desired to determine an amount and a distribution pattern of fluid injected by the injector. The knowledge of distribution pattern of injected fluid would assist in determining the efficiency of a Selective Catalyst Reduction module.

Conventionally, test benches are employed to assist in determining the fluid dispersion or spray pattern by the fuel injectors within a predetermined time interval. The test benches typically include a grid having multiple orifices, an injector disposed above the grid to spray fluid, multiple beakers arranged beneath the grid, and multiple tubes connecting each orifice of the grid to one respective beaker. The fluid sprayed by the injector passes through a tube and is collected in a beaker. Thereafter, an operator records the amount of fluid collected in each beaker and, when the tests are concluded, empties the beakers. Due to such human intervention, determining the amount of fluid collected may be time-consuming and the results may be error-prone.

U.S. Pat. No. 6,053,037 ('037 patent) describes a spray distribution measuring device that includes a chamber having a spray nozzle as a measurement object at the top; a saucer arranged below the spray nozzle within the chamber and partitioned into a plurality of regions each having a prescribed area; measuring tubes each installed substantially vertically from each region of the saucer and having a prescribed sectional area, the upper end of each of which opens into the bottom of each region of the saucer; pressure sensors, each installed at the lower end of each of the measuring tubes to measure the head pressure of each measuring tube; and a controller for computing a difference between the pressure applied to the pressure sensor and an initial pressure, and determining the spray distribution on the basis of a difference between the head pressure of the test solution accumulated in each measuring tube and the initial pressure before the spraying. Whilst such configuration automates many of the test procedures, the spray distribution measuring device of the '037 patent may still require human intervention for completing the process.

### SUMMARY OF THE DISCLOSURE

In one aspect of the present disclosure, a system for determining a spray pattern of an injector is provided. The system includes a chamber having means for mounting the injector. The system further includes a grid disposed within the chamber. The grid includes an array of orifices to receive fluid sprayed by the injector. The system also includes a plurality of containers positioned beneath the chamber for collecting the fluid. The system also includes a plurality of tubes to connect the grid to the plurality of containers. Each of the plurality of tubes allows flow of fluid from an orifice of the array of orifices to a container of the plurality of containers. The system also includes a plurality of load cells. Each of the plurality of load cells is coupled to one of the plurality of containers and is configured to generate a voltage signal corresponding to an amount of fluid collected in the container. The system also includes a plurality of solenoids. Each of the plurality of solenoids is coupled to one of the plurality of containers and is configured to drain the fluid from the container. The system further includes a control module coupled to the plurality of load cells and the plurality of solenoids. The control module is configured to receive the voltage signal from each of the plurality of load cells. The control module is also configured to determine, based on the received voltage signal, the amount of fluid collected in each of the plurality of containers. The control module is also configured to generate, based on the amount of fluid collected, an output indicative of an amount of fluid collected in each of the plurality of containers and a distribution pattern of the collected fluid. Further, the control module is configured to actuate each of the plurality of solenoids to drain the fluid from each of the plurality of containers.

Other features and aspects of this disclosure will be apparent from the following description and the accompanying drawings.

### BRIEF DESCRIPTION OF THE DRAWINGS

FIG. 1 is a perspective view of a system for determining a spray pattern of an injector;

FIG. 2 is a perspective view of a fluid measurement module of the system of FIG. 1, being attached to a container; and

FIG. 3 is a block diagram illustrating operation of the fluid measurement module of FIG. 2.

### DETAILED DESCRIPTION

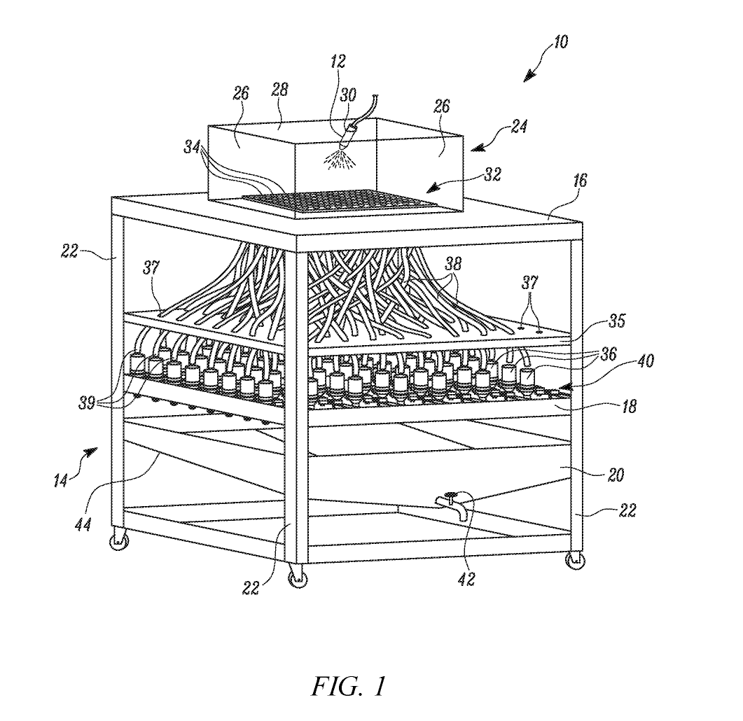

Referring to FIG. 1, a perspective view of a system 10 for determining a spray pattern of an injector 12 is shown. The injector 12 is embodied as an aftertreatment Diesel Exhaust Fluid (DEF) injector. The system 10 includes a frame 14 having a first platform 16, a second platform 18 positioned beneath the first platform 16, and a drain pan 20 positioned beneath the second platform 18. The frame 14 also includes a number of vertical members 22 to support the first platform 16, the second platform 18, and the drain pan 20 at their respective positions, as shown in FIG. 1.

The system 10 also includes a chamber 24 mounted on the first platform 16. In an example, the chamber 24 may be provided as a hollow box-like structure. As such, the chamber 24 is defined by a number of vertical walls 26 and a horizontal wall 28. The vertical walls 26 and the horizontal wall 28 can be made of a transparent material, such as acrylic sheet or fiberglass. In one example, the vertical walls 26 of the chamber 24 may be attached to the first platform 16 and the horizontal wall 28 may be detachably coupled to the vertical walls 26. In such an arrangement, the horizontal wall 28 can be removed to access a space within the chamber 24. In another example, the chamber 24 may be removably mounted on the first platform 16. Further, the chamber 24 includes means for mounting the injector 12. For instance, the horizontal wall 28 can include an aperture 30 for receiving the injector 12. In an example, a sealing member (not shown), such as a rubber sealing, may be disposed between the injector 12 and a periphery of the aperture 30 for securing the injector 12. The sealing member may also aid in positioning the injector 12 at a predetermined angle with respect to the horizontal wall 28. In an example, the predetermined angle may be selected from a range of 15 degrees to 45 degrees. Mounting and positioning of the injector 12 may also be achieved through other methods, albeit with few variations to the examples described herein.

The system 10 further includes a grid 32 disposed within the chamber 24 and supported on the first platform 16. In an example, the grid 32 may be embodied as a thin plate. The grid 32 is positioned on the first platform 16 in a manner, such that a fluid sprayed by the injector 12 impinges on the grid 32. The grid 32 can either be removably disposed on the first platform 16 via fasteners (not shown). The grid 32 includes an array of orifices 34 provided along a length and a breadth of the grid 32, to receive the fluid sprayed by the injector 12. In the illustrated embodiment, the array of orifices 34 is provided in a matrix configuration including multiple rows and multiple columns. In an example, the grid 32 may include, but not limited to, thirteen orifices in each row and thirteen orifices in each column. The number of orifices 34 in each row and each column may vary based on type of injector 12 and dosing rate of the injector 12. The ‘number of orifices 34’ is hereinafter commonly referred to as the orifices 34 or individually referred to as the orifice 34.

In an example, the first platform 16 may include an opening (not shown), where a perimeter of the opening is less than a perimeter of the grid 32. In such a condition, the grid 32 may be positioned on the first platform 16 in a manner, such that the orifices 34 are exposed towards the second platform 18 through the opening provided in the first platform 16.

A number of containers 36 are employed in the system 10 and positioned beneath the chamber 24 for collecting the fluid sprayed by the injector 12. In an example, the containers 36 may be made of poly methyl methacrylate (PMMA), alternatively referred to as acrylic glass or Plexiglass. The ‘number of containers 36’ is hereinafter commonly referred to as the containers 36 or individually referred to as the container 36. The containers 36 may be embodied as cylindrical tubes or funnels. The containers 36 may be arranged in a matrix configuration having a number of rows and a number of columns, as shown in FIG. 1, on the second platform 18. Each container 36 may be positioned at a predetermined distance from adjacent containers 36 when the container 36 is arranged in the matrix configuration. The number of containers 36 provided on the second platform 18 corresponds to the number of orifices 34. In such an arrangement, each container 36 is in fluid communication with one orifice 34 of the grid 32.

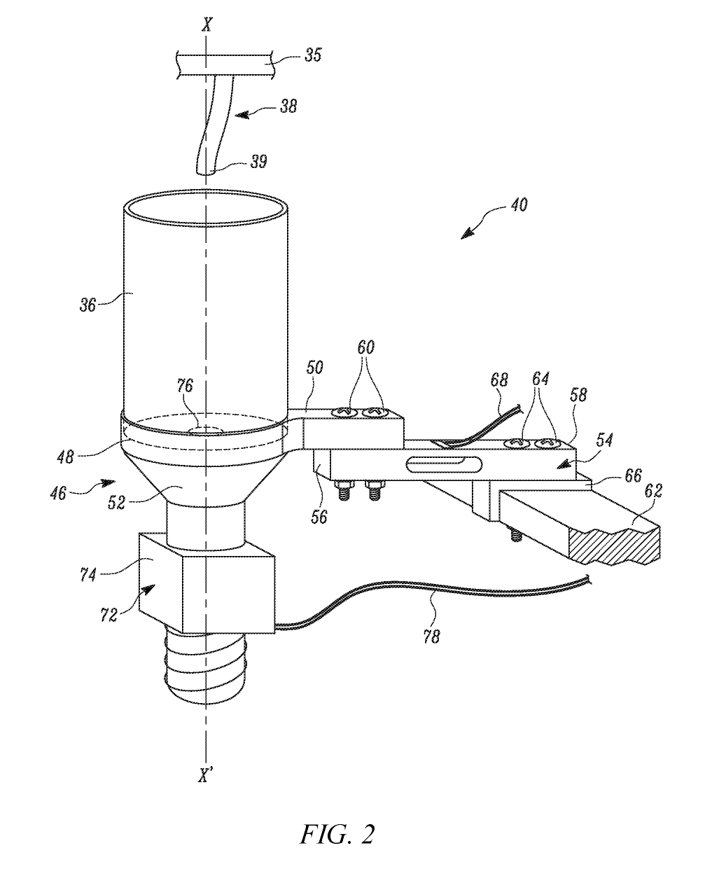

The system 10 further includes a number of tubes 38 to connect the grid 32 with the containers 36 and a supporting grid 35 positioned above the second platform 18 to support the number of tubes 38. Specifically, the supporting grid 35 includes a number of apertures, such as an aperture 37, provided along multiple rows and multiple columns, as shown in FIG. 1. The ‘number of tubes 38’ is hereinafter commonly referred to as the tubes 38 or individually referred to as the tube 38. One end (not shown) of each tube 38 is inserted through the opening provided in the first platform 16 and connected to one orifice 34, and an other end 39 of each tube 38 is inserted through one aperture 37 and disposed above one container 36. As such, each tube 38 allows flow of fluid from the orifice 34 to the container 36. Further, each container 36 is coupled to a fluid measurement module 40, which will be described with reference to FIG. 2. Each fluid measurement module 40 assists in determining amount of fluid collected in the corresponding container 36 and draining of the fluid from the corresponding container 36.

Furthermore, the drain pan 20 provided beneath the second platform 18 aids in collecting the fluid drained from each container 36. The drain pan 20 includes a valve 42 to drain the fluid from the drain pan 20. A bottom portion 44 of the drain pan 20 is inclined with respect to a horizontal plane and inclined towards the valve 42, so that the fluid drained from the containers 36 is collected at the valve 42. In an example, the valve 42 may be manually operated by an operator to drain the fluid collected from the drain pan 20.

FIG. 2 illustrates a perspective view of the fluid measurement module 40. In the preferred embodiment, the system 10 includes multiple fluid measurement modules 40, where each fluid measurement module 40 is coupled to one container 36 of the number of containers 36. As such, the number of fluid measurement modules 40 corresponds to the number of containers 36. Each fluid measurement module 40 is detachably coupled to the respective container 36.

Although the system 10 includes multiple fluid measurement modules 40, FIG. 2 will be described with respect to one fluid measurement module 40. As shown in FIG. 2, the fluid measurement module 40 includes a mounting bracket 46 for supporting the container 36. In an example, the mounting bracket 46 may include a hollow portion to receive a base 48 of the container 36. The mounting bracket 46 also include a coupling arm 50 that extends radially outward from a body 52 of the fluid measurement module 40, as shown in FIG. 2. Further, the fluid measurement module 40 includes a load cell 54 having a first end 56 and a second end 58. The first end 56 of the load cell 54 is located beneath the coupling arm 50 and is coupled to the coupling arm 50 via a pair of fasteners 60, as shown in FIG. 2. A length of the coupling arm 50 may be predetermined so as to withstand the weight of the container 36 in an empty condition and a filled condition. Accordingly, the length of the coupling arm 50 aids in retaining the container 36 in a vertical manner, i.e., along a vertical axis X-X′, as shown in FIG. 2.

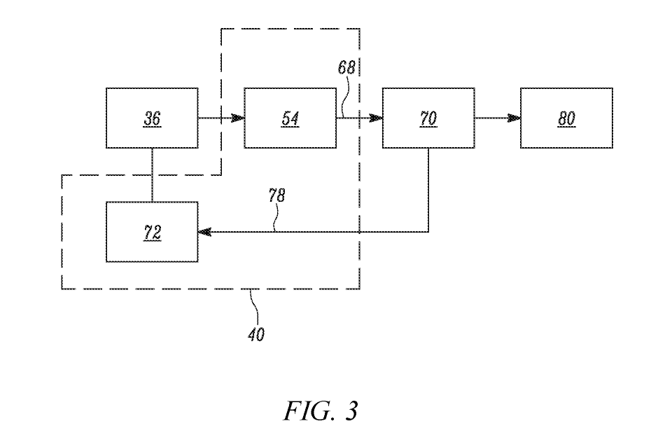

The second end 58 of the load cell 54 is coupled to a horizontal member 62 via another pair of fasteners 64. In an example, a support member 66 may be disposed between the second end 58 of the load cell 54 and the horizontal member 62, as shown in the FIG. 2, while coupling the load cell 54 with the horizontal member 62. As the fluid gets collected in the container 36, weight of the container 36 increases. Due to the coupling between the load cell 54 and the coupling arm 50, the load cell 54 generates a voltage signal ‘V’ corresponding to an amount of fluid collected in the container 36. A first electrical lead 68 is drawn from the load cell 54 to transmit the generated voltage to a control module 70 (shown in FIG. 3).

The fluid measurement module 40 also includes a solenoid 72 coupled to the container 36 to drain fluid from the container 36. In an example, the solenoid 72 may be embodied as an electrically actuated valve. A housing 74 of the solenoid 72 may be coupled to the mounting bracket 46. In order to drain the fluid from the container 36, a flow control element (not shown) of the solenoid 72 may be coupled to an opening 76 provided at the base 48 of the container 36. In the preferred embodiment, a second electrical lead 78 drawn from the solenoid 72 may be in communication with the control module 70. As such, the solenoid 72 drains the fluid from the container 36 based on actuation by the control module 70. To this end, it will be understood that each fluid measurement module 40 includes one load cell 54 and one solenoid 72, both connected to the control module 70.

Referring to FIG. 3, a block diagram illustrating operation of the fluid measurement modules 40 based on actuation by the control module 70. In an example, the control module 70 may be a processor that includes a single processing unit or a number of processing units, all of which include multiple computing units. The explicit use of the term ‘processor’ should not be construed to refer exclusively to hardware capable of executing a software application. Rather, in this example, the control module 70 may be implemented as one or more microprocessor, microcomputers, digital signal processor, central processing units, state machine, logic circuitries, and/or any device that is capable of manipulating signals based on operational instructions. Among the capabilities mentioned herein, the control module 70 may also be configured to receive, transmit, and execute computer-readable instructions. In another example, the control module 70 may be embodied as an Arduino Uno controller or eDAQ processor.

In operation, at an instant when the system 10 is started, the load cell 54 generates a first voltage value ‘V1’ in the voltage signal ‘V’, indicative of a sum of weight of the container 36, weight of the mounting bracket 46, and weight of the solenoid 72 coupled to the container 36 via the mounting bracket 46. The load cell 54 transmits the first voltage value ‘V1’ to the control module 70 via the first electrical lead 68. Subsequently, the fluid sprayed by the injector 12 impinges on the grid 32 and the orifices 34 of the grid 32 receive the fluid. Since the tube 38 connects the grid 32 with the containers 36, fluid received by each orifice 34 is allowed to flow to a corresponding container 36.

Once the fluid is received in the container 36, the load cell 54 generates a second voltage value ‘V2’ in the voltage signal ‘V’. The second voltage value ‘V2’ is indicative of a sum of weight of the container 36, weight of the fluid received in the container 36, weight of the mounting bracket 46, and weight of the solenoid 72 coupled to the container 36 via the mounting bracket 46. The second voltage value ‘V2’ is also transmitted by the load cell 54 to the control module 108, via the first communication link 125. Based on the voltage signal received, the control module 70 determines the amount of fluid collected in the container 36. Specifically, the control module 70 determines a difference between the first voltage value ‘V1’ and the second voltage ‘V2’ of the voltage signal. The difference between the first voltage value ‘V1’ and the second voltage ‘V2’ is indicative of the amount of fluid collected in the container 36.

In one example, the control module 70 may be configured to continuously receive the voltage signal ‘V’ from the load cell 54 for a predefined time period, such as 5 minutes. In such a scenario, the load cell 54 progressively increases voltage value of the voltage signal based on progressive increase in amount of fluid collect in the container 36. Accordingly, the voltage value generated by the load cell 54 at the instant of start of the system 10 may be considered as the first voltage signal ‘V1’ by the control module 70. Further, the voltage value received by the load cell 54 on lapse of the predefined time period may be considered as the second voltage value ‘V2’. In such cases, the control module 70 can generate an actual amount of fluid collected in the container 36 for a desired time period.

It should be understood that each load cell 54 of the number of fluid measurement modules 40 would be connected to the control module 70 in a similar manner and, accordingly, the control module 70 can be configured to receive the voltage values from each load cell 54. Based on the received voltage signals from each load cell 54, the control module 70 is configured to generate an output indicative of the amount of fluid collected in each corresponding container 36 and a distribution pattern of the fluid collected in the container 36.

In an example, the control module 70 may include a memory for storing data associated with the amount of fluid collected in each container 36. The control module 70 may store the data in a matrix manner corresponding to the arrangement of the containers 36. For instance, the control module 70 may be configured to generate the output in form of table. An amount of fluid collected and determined by the control module 70 for a fifth container 36 in a third row of the containers 36 may be appended to a corresponding box in the table. Similarly, the control module 70 can append values to the table based on voltage signals received from corresponding load cells 54. As such, the output generated by the control module 70 can include a position of the container 36 on the second platform 18 and a value of amount of fluid collected in that container 36.

In another example, the control module 70 can generate a graphical representation of data associated with the amount of fluid collected in each container 36. The graphical representation can include a number of circles corresponding to the number and arrangement of the containers 36 in the system 10. Each circle in the graphical representation can be provided with a color code indicating the amount of fluid collected in that container 36. A color code table may also be generated along with the graphical representation to indicate a range of amount of fluid against each color. As such, the graphical representation may indicate the distribution pattern of fluid in the containers 36 and the spray pattern of the injector 12.

Further, the control module 70 may be configured to transmit the generated output to a user interface 80, such as a computer system or a mobile device. The tabular output or the graphical representation may be displayed on the user interface 80. In an example, the user interface 80 may be capable of generating outputs in desired formats on receipt of values, from the control module 70, regarding amount of fluid collected in each container 36.

The control module 70 also actuates the solenoid 72, via the second electrical lead 78, to drain the fluid from the container 56. It should be understood that the control module 70 actuates the solenoid 72 of each of the fluid measurement modules 40 to drain fluid from the respective containers 36. In one example, the control module 70 may actuate the solenoid 72 based on predetermined amount of fluid collected in the container 36, such as 20 ml. In another example, the control module 70 may actuate the solenoid 72 based on a predetermined time interval, such as 5 minutes from the start of the system 10. In yet another example, the control module 70 may either actuate all solenoids 72 at once or actuate each solenoid 72 one after the other.

### INDUSTRIAL APPLICABILITY

The present disclosure relates to the system 10 for determining the spray pattern of the injector 12. Since the system 10 of the present disclosure employs the fluid measurement modules 40, requirement of an operator at the system 10, for the purpose of recording the amount of fluid collected in each container 36, is eliminated. In particular, the load cell 54 of each fluid measurement module 40 generates the voltage signal corresponding to the amount of fluid collected in the corresponding container 36. The control module 70 receives the voltage signal from each load cell 54, determines the amount of fluid collected in the corresponding container 36, and generates the output indicative of the amount of fluid collected in each container 36 and the distribution pattern of the collected fluid. As such, accuracy of determining the amount of fluid and the distribution pattern is enhanced. In addition, the control module 70 minimizes overall time involved in recording and output generation.

Further, owing to the presence of solenoids 72, fluid collected in the containers 36 can be automatically drained. Accordingly, the system 10 can be subjected to continuous pattern testing of the injector 12 at various range of dosing rates without paying much attention on fluid levels in the containers 36. Therefore, the system 10 of the present disclosure provides an efficient and affordable way of determining the spray pattern of the injector 12.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A system for determining a spray pattern of an injector, the system comprising:
a chamber having means for mounting the injector;
a grid disposed within the chamber, the grid including an array of orifices to receive fluid sprayed by the injector;
a plurality of containers positioned beneath the chamber for collecting the fluid;
a plurality of tubes to connect the grid to the plurality of containers, wherein each of the plurality of tubes allows flow of fluid from an orifice of the array of orifices to a container of the plurality of containers;
a plurality of load cells, each of the plurality of load cells coupled to one of the plurality of containers and configured to generate a voltage signal corresponding to an amount of fluid collected in the container;
a plurality of solenoids, each of the plurality of solenoids coupled to one of the plurality of containers and configured to drain the fluid from the container; and
a control module coupled to the plurality of loads cells and the plurality of solenoids, wherein the control module is configured to:
receive the voltage signal from each of the plurality of load cells;
determine, based on the received voltage signal, the amount of fluid collected in each of the plurality of containers;
generate, based on the amount of fluid collected, an output indicative of an amount of fluid collected in each of plurality of containers and a distribution pattern of the collected fluid; and
actuate each of the plurality of solenoids to drain the fluid from each of the plurality of containers.
